(19) United States
(12) Patent Application Publication
(10) Pub. No.: US 2008/0175470 A1
(43) Pub. Date: Jul. 24, 2008

(54) IMAGE READER AND IMAGE FORMING APPARATUS

(75) Inventor: Masaki Kato, Osaka-shi (JP)

Correspondence Address: CASELLA & HESPOS, 274 MADISON AVENUE, NEW YORK, NY, 10016, US

(73) Assignee: KYOCERA MITA CORPORATION, Osaka-shi (JP)

(21) Appl. No.: 12/014,826

(22) Filed: Jan. 16, 2008

(30) Foreign Application Priority Data
Jan. 23, 2007 (JP) 2007-012330

(51) Int. Cl. G06K 9/00

(52) U.S. Cl. 382/151

(57) ABSTRACT

Disclosed is an image reader, which comprises a circuit board (36) designed to mount, to the same surface thereof, an image pickup device (34) and an IC device (128). The circuit board (36) is fixedly fastened to horizontally opposite ends of a board support plate (114) by a fastening member (120), in such a manner that it is in contact with a plurality of protrusion members (116, 118) provided at respective positions around a window (112) of a rear surface of the board support plate (114), while allowing a light-receiving surface of the image pickup device (34) to face an imaging lens (38).

### BACKGROUND OF THE INVENTION

1. Field of the Invention

The present invention relates to an image reader designed to read an image of a document by an optical system and focus the document image onto a light-receiving surface of an image pickup device through an imaging lens, and an image forming apparatus, such as a copy machine, a facsimile machine or a complex machine with a combination of functions thereof, which is equipped with the image reader.

2. Description of the Related Art

Recent years, an image forming apparatus, such as a copy machine or a printer, has been widely used which has an image forming section adapted to develop an electrostatic latent image formed on a surface of a photosensitive drum so as to form a toner image thereon, and transfer the toner image onto a recording sheet. The image forming apparatus is equipped with an image reader which comprises an optical system adapted to emit light onto a surface of a document so as to read an image of the document, an imaging lens, and an image pickup device configured as a line sensor, such as a CCD (Charge-Coupled Device), wherein the document image read by the optical system is focused onto a light-receiving surface of the image pickup device through the imaging lens (see, for example, JP 2002-171387A).

FIG. 5 is a fragmentary top view schematically showing a conventional image reader provided in an image forming apparatus, as disclosed, for example, JP 2002-171387A. As shown in FIG. 5, a structure for mounting an image pickup device 200 to a circuit board 202 through a lead wire (not shown) is designed such that a board support plate 204 made of a rigid material is interposed between the image pickup device 200 and the circuit board 202 while allowing the lead wire to penetrate through a through-hole (not shown) formed therein, and the circuit board 202 is fixedly fastened to the board support plate 204 at longitudinally opposite ends thereof by use of a screw member 206.

In the above image reader, when a front surface of the circuit board 202 located on the side of the image pickup device 200 (i.e., on a frontward side “F” in FIG. 5) increases in temperature due to heat generated from the image pickup device 200 in a driven state, an amount of linear expansion in the front surface of the circuit board 202 becomes greater than that in a rear surface of the circuit board 202 located on an opposite side of the front surface (i.e., on a rearward side “R” in FIG. 5), which can otherwise cause the front surface of the circuit board 202 to deform into a convex shape (i.e., convex warping of the circuit board 202 in the arrowed direction in FIG. 5). In this situation, the board support plate 204 interposed between the image pickup device 200 and the circuit board 202 can suppress the convex warping to prevent a distance between an imaging lens and the image pickup device 200 in the driven state from being largely changed relative to a normal distance adjusted during assembling so as to avoid deterioration in image quality due to the convex warping of the circuit board 202.

Although the above conventional image reader can suppress the convex warping of the circuit board 202, it involves the following problem. Differently from the above situation, when the rear surface of the circuit board 202 located on the rearward side “R” increases in temperature due to heat generated from an IC device 208 which is mounted thereon to constitute a driving circuit for the image pickup device 200, an amount of linear expansion in the rear surface of the circuit board 202 becomes greater than that in the front surface of the circuit board 202 located on the frontward side “F” to cause the front surface of the circuit board 202 to deform into a concave shape (i.e., concave warping of the circuit board 202 in a direction opposite to the arrowed direction). In this situation, along with the concave warping of the circuit board 202, the image pickup device 200 is moved rearwardly by a slight gap which has been inevitably formed between the image pickup device 200 and the board support plate 204 during the assembling. Thus, the distance between the imaging lens and the image pickup device 200 in the driven state is changed relative to the normal distance adjusted during the assembling, resulting in deterioration in image quality due to the concave warping of the circuit board 202.

### SUMMARY OF THE INVENTION

In view of the above circumstances, it is an object of the present invention to provide an image reader and an image forming apparatus which are free from the occurrence of deterioration in image quality due to warping of a circuit board caused by heat generated from an image pickup device or an IC device.

In order to achieve the above object, the present invention provides an image reader designed to read an image of a document by an optical system and focus the document image onto a light-receiving surface of an image pickup device through an imaging lens, and an image forming apparatus equipped with the image reader. The image reader comprises an image pickup unit including: a lens mounting plate which mounts thereto the imaging lens; a circuit board which mounts, to a same surface thereof, the image pickup device and an IC device constituting a driving circuit for the image pickup device; and a board support plate disposed to extend upwardly relative to the lens mounting plate in opposed relation to the imaging lens and formed to support the circuit board by a rear surface thereof located on an opposite side of the imaging lens, in such a manner as to allow a light-receiving surface of the image pickup device to face the imaging lens, wherein the circuit board is in contact with a protrusion member provided in a region between horizontally opposite ends of the rear surface of the board support plate, and fixedly fastened to the board support plate at the horizontally opposite ends by use of a fastening member.

In the present invention, the circuit board is designed to mount, to the same surface thereof, the image pickup device and the IC device, and the board support plate is designed to support the circuit board while allowing the circuit board to be in contact with the protrusion member provided on the rear surface thereof. Thus, the image reader and the image forming apparatus of the present invention can suppress the occurrence of convex warping in the surface of the circuit board having the image pickup device and the IC device mounted thereto, to eliminate the risk of deterioration in image quality due to warping of the circuit board caused by heat generated from the image pickup device and the IC device.

These and other objects, features and advantages of the invention will become apparent upon reading the following detailed description along with the accompanying drawings.

### BRIEF DESCRIPTION OF THE DRAWINGS

FIG. 1 is an explanatory diagram schematically showing an internal structure of an image forming apparatus equipped with an image reader according to one embodiment of the present invention;

FIG. 2 is an explanatory perspective view showing one specific example of an image pickup unit in the image reader in FIG. 1;

FIG. 3 is a sectional side view taken along the line A-A in FIG. 2;

FIG. 4 is a fragmentary perspective rear view showing a board support plate in the image pickup unit illustrated in FIG. 1;

FIG. 5 is a fragmentary top view schematically showing one example of a conventional image reader.

### DETAILED DESCRIPTION OF THE PREFERRED EMBODIMENTS

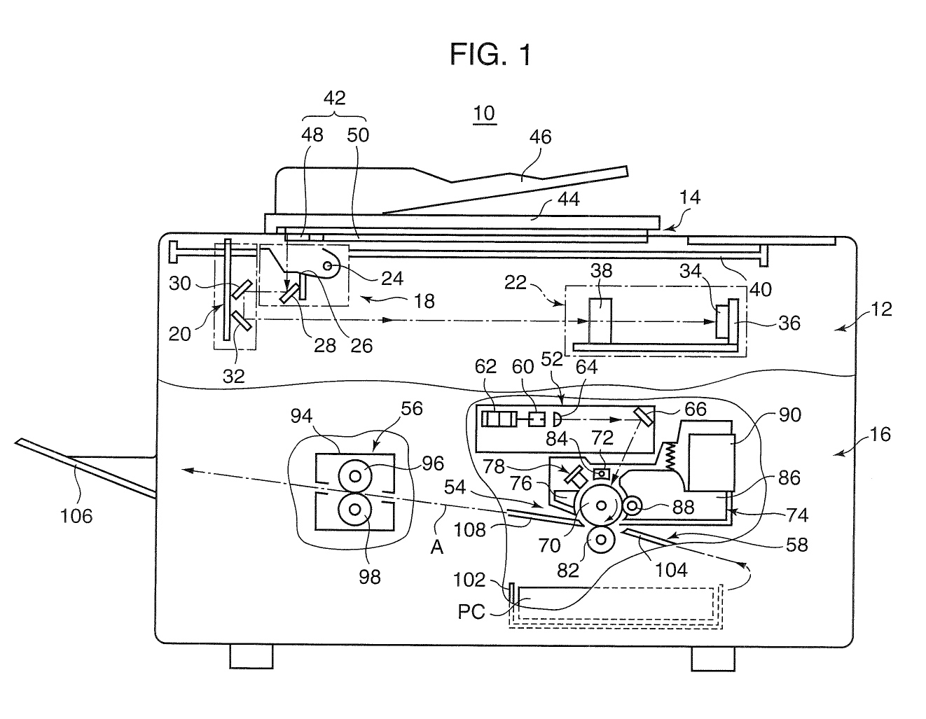

The present invention will now be specifically described based on an embodiment thereof. FIG. 1 is an explanatory diagram schematically showing an internal structure of an image forming apparatus equipped with an image reader according to one embodiment of the present invention. In FIG. 1, the image forming apparatus 10 is a copy machine designed to form an image onto a recording sheet based on a document image acquired by an image pickup device adapted to convert light into an electric signal. The image forming apparatus 10 is provided with an image reading section 12 for reading an image of a document, a document loading section 14 located above the image reading section 12, and an image forming section 16 located below the image reading section 12.

The image reading section 12 serves as an image reader, and comprises a first optical system 18, a second optical system 20 and an image pickup unit 22. The first optical system 18 is provided as a means to emit light onto a surface of a document so as to read an image of the document. The first optical system 18 is integrally provided with an exposure light source 24 composed of a halogen lamp or the like, a reflector plate 26 for directing light emitted from the exposure light source 24, toward the document surface, and a reflecting mirror for directing light reflected by the document surface (hereinafter referred to as “document-induced reflected light”) after being emitted from the exposure light source 24, in a horizontal direction, so as to lead the document-induced reflected light to the second optical system 28.

The second optical system 20 is disposed on a left (in FIG. 1) side of the first optical system 18, and provided as a means to lead the document-induced reflected light obtained by the first optical system 18 to the image pickup unit 22. The second optical system 20 includes a first reflecting mirror 30 and a second reflecting mirror 32 for leading the document-induced reflected light reflected by the reflecting mirror 28 of the first optical system 18, to the image pickup unit 22. The first and second reflecting mirrors 30, 32 are formed and arranged to allow the document-induced reflected light reflected by the reflecting mirror 28 of the first optical system 18 to be received by the first reflecting mirror 30 so as to be lead to the second reflecting mirror 32, and then reflected and directed in a horizontal direction by the second reflecting mirror 32 so as to be let to the image pickup unit 22.

The image pickup unit 22 is disposed on a right (in FIG. 1) side of the second optical system. The image pickup unit 22 includes a circuit board 36 which mounts thereto an image pickup device 34 configured as a line sensor comprising a CCD (Charge Coupled Device) adapted to convert light into an electric signal so as to pick up a document image consisting of the document-induced reflected light, and an imaging lens 38 which is disposed on the side of the second optical system 20 relative to the circuit board 36 and adapted to focus the document image consisting of the document-induced reflected light onto a light-receiving surface of the image pickup device 34. The document image read by the image pickup device 34 will be converted into a digital signal after being subjected to a given signal processing, and stored in a storage device (not shown). An example of a specific structure of the image pickup unit 22 will be described later.

A pair of guide rails 40 (only one of the guide rails 40 is illustrated in FIG. 1) are provided to extend along respective laterally (i.e., depthwise in FIG. 1) opposite ends of an upper wall of the image reading section 12 so as to guide the first optical system 18 and the second optical system 20 in a given range between two positions in left and right (in FIG. 1) ends of the upper wall. Each of the first optical system 18 and the second optical system 20 is engaged with the guide rails 40, and adapted to be reciprocatingly moved along the guide rails by an optical-system driving motor (not shown).

The document loading section 14 comprises a contact glass 42 attached to an opening formed in the upper wall of the image reading section 12, and a document presser member 44 adapted to be selectively opened and closed relative to an upper surface of the contact glass 42, and an automatic document feeder 46 provided above the document presser member 44. In this embodiment, the contact glass 42 includes a first contact glass 48 arranged to allow a document fed by the automatic document feeder 46 to pass through an upper surface thereof, and a second contact glass 50 arranged to allow a document to be placed thereon in a static condition. The document presser member 44 has an upper surface formed as a tray portion for receiving a plurality of documents ejected from the automatic document feeder 46.

Specifically, the automatic document feeder 46 is operable to automatically feed a stack of documents placed at a given position thereof, one-by-one, onto the first contact glass 48, and, after completion of a reading operation, sequentially return the documents to the tray portion formed on the upper surface of the document presser member 44.

The image forming section 16 comprises a laser scanner unit 52, an image forming unit 54, a fixing unit 56 and a sheet transport mechanism 58. The laser scanner unit 52 is provided as a means to subject an after-mentioned photosensitive drum 70 to exposure by a laser beam based on data about a document image read from the storage device (not shown), i.e., a document image picked up by the image pickup device 34 and then stored in the storage device. The laser scanner unit 52 includes a laser beam-emitting module 60 for converting a modulated signal generated based on the read image data into a laser beam and outputting the laser beam, a rotatable multifaceted polygon mirror 62 for reflecting the laser beam output from the laser beam-emitting module 60 toward the after-mentioned photosensitive drum 70, an fθ lens 64 for correcting a distortion of the laser beam reflected by the polygon mirror 62, and a reflecting mirror 66 for leading the laser beam corrected by the fθ lens 64 to an exposure position of the after-mentioned photosensitive drum 70.

The polygon mirror 62 is designed to be rotationally driven in a given direction at a constant speed by a polygon-mirror driving motor (not shown) so as to allow the laser beam output from the laser beam-emitting module 60 to be sequentially reflected by the respective mirror facets each having a reflection angle, and scanned in an axial (i.e., longitudinal) direction of the after-mentioned photosensitive drum 70. That is, the polygon mirror 62 is operable to irradiate the after-mentioned photosensitive drum 70 with the laser beam output from the laser beam-emitting module 60 in a deflected manner so as to write an electrostatic latent image onto after-mentioned photosensitive drum 70.

The image forming unit 54 includes an electrostatic charger 72, a developing module 74, a clearing module 76 and a light-emitting module 78, which are disposed in this order along an outer peripheral surface of a photosensitive drum 70 adapted to be rotated at a constant speed. The photosensitive drum 70 is designed to be rotationally driven in a clockwise direction (arrowed direction in FIG. 1) by a photosensitive-drum driving motor (not shown). The charger 72 is operable to form an electrostatically charged region on the outer peripheral surface of the photosensitive drum 70, at an opposed position between the photosensitive drum 70 and the charger 72. Then, the laser scanner unit 52 is operable to output a laser beam based on a document image so as to irradiate the electrostatically charged region with the laser beam to form an electrostatic latent image, and the developing module 74 is operable to develop the electrostatic latent image into a toner image, at an opposed position between the photosensitive drum 70 and the developing module 74. The image forming unit 54 further includes a transfer roller 83 which is disposed below the photosensitive drum 70, and adapted to transfer the toner image formed on the photosensitive drum 70, onto a recording sheet, at an opposed position between the photosensitive drum 70 and the transfer roller 83. The cleaning module 76 is operable to remove toner remaining on the outer peripheral surface of the photosensitive drum 70 after completion of the transfer of the toner image onto the recording sheet, at an opposed position between the photosensitive drum 70 and the cleaning module 76. Then, the light-emitting module 78 is operable to remove charges remaining thereon the outer peripheral surface of the photosensitive drum 70.

The charger 72 may be a type which comprises a charge wire 84 having a length equal to a longitudinal length of the photosensitive drum 70. In this case, a driving voltage is applied from a driving power supply (not shown) to the charge wire 84 to give a charge to the outer peripheral surface of the photosensitive drum 70 so as to form an electrostatically charged region thereon. The developing module 74 may be a type which uses a two-component based developer including a toner and a carrier, and comprises a developer housing 86 capable of containing the developer therein, a developing roller 88 partially received inside the developer housing 86 and disposed in adjacent relation to the photosensitive drum 70, and a toner cartridge 90 mounted to an upper portion of the developer housing 86.

The developer housing 86 is internally provided with an agitating roller (not shown) for agitating the developer to induce friction between the carrier and the toner so as to electrically charge the toner. The developing roller 88 has an outer peripheral surface which is electrostatically charged by applying a driving voltage is applied from a driving power supply (not shown) thereto. Thus, the developing roller 88 is operable to electrostatically attract the toner onto the electrostatically charged outer peripheral surface thereof and attach the attracted toner onto the outer peripheral surface of photosensitive roller 70. The toner cartridge 90 is a demountable container filled with toner for replenishing the developer housing 86 therewith.

The light-emitting module 78 serves as a charge eraser, and comprises an array of semiconductor light-emitting elements, such as light-emitting diodes, which are arranged along the axial direction of the photosensitive drum 70 while orienting respective light-emitting surfaces of the semiconductor light-emitting elements toward the outer peripheral surface of the photosensitive drum 70.

The fixing unit 56 is provided as a means to heat a recording sheet with a toner image transferred by the image forming unit 54 so as to perform a fixing process. The fixing unit 56 includes a fixing roller 96 which is disposed in an upper region of an internal space of a heat shielding box 94 and adapted to be heated by an built-in heater, and a pressing roller 98 which is disposed in a lower region of the internal space of the heat shielding box 94 and adapted to be brought into press contact with the fixing roller 96.

The sheet transport mechanism 58 is provided as a means to transport a recording sheet along a path indicated by the arrow A in FIG. 1. The sheet transport mechanism 58 includes a cassette loading portion 102 adapted to be loaded with a sheet cassette PC for receiving therein a plurality of given-size recording sheets in a stacked state, an upstream transport passage 104 for leading to the photosensitive roller 70 a recording sheet extracted from the sheet cassette PC in the cassette loading portion 102 by a sheet-feeding roller (not shown), and a downstream transport passage 108 for leading a recording sheet with a toner image transferred from the photosensitive roller 70 to a catch tray attached to a left (in FIG. 1) wall of the image forming section 16, via a nip zone defined between the fixing roller 96 and the pressing roller 98 of the fixing unit 56.

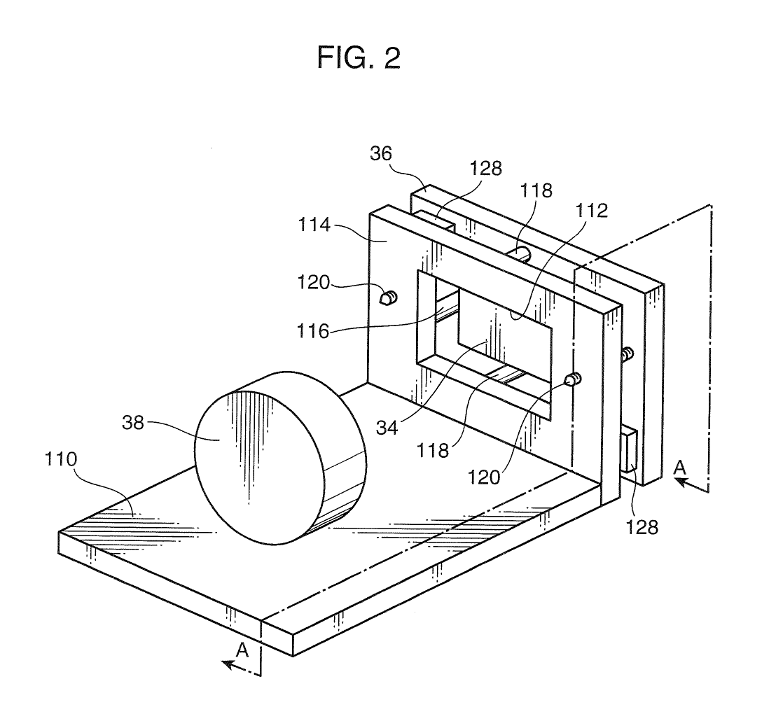

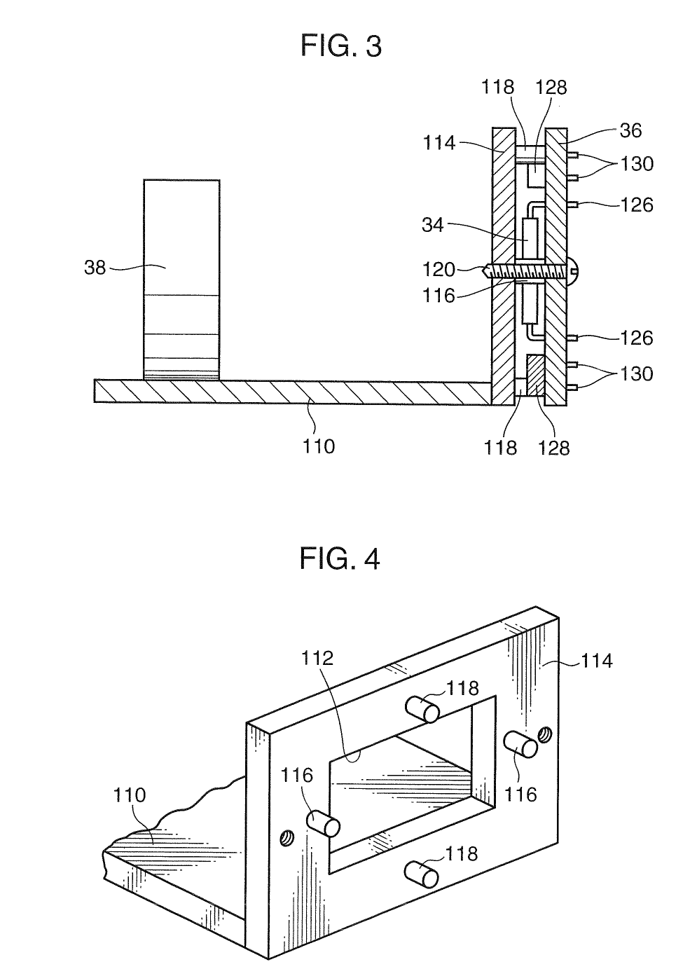

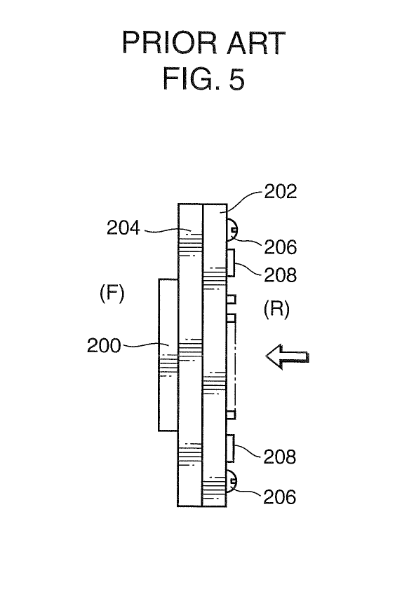

FIG. 2 is an explanatory perspective view showing one specific example of the aforementioned image pickup unit 22, and FIG. 3 is a sectional side view taken along the line A-A in FIG. 2. In this embodiment, the image pickup unit 22 includes a flat-shaped lens mounting plate 110 made, for example, of a metal material or a resin material, and a board support plate 114 which is made of a rigid material, such as metal or hard resin, and disposed to extend upwardly from a position where it is fixedly fastened to an edge surface of one of opposite ends of the lens mounting plate 110 in a paired manner by means of screwing or the like. The board support plate 114 has a central region formed as a through-hole serving as a window 112 having a size greater than that of the image pickup device 34.

The imaging lens 38 is mounted to the lens mounting plate 110 in a vicinity of the other end of the lens mounting plate 110 on the side of the second optical system 20. FIG. 4 is a fragmentary perspective rear view showing the board support plate 114, when viewed in a direction opposite to a viewing direction in FIG. 2. In this connection, as used in this specification, the term “front surface” of the board support plate 114 means one of opposite surfaces of the board support plate 114 which faces the imaging lens 38, and the term “rear surface” of the board support plate 114 means the other surface of the board support plate 114 on an opposite side of the front surface. As best shown FIG. 4, a first pair of protrusion members 116 are formed on a rear surface of the board support plate 114 at respective positions opposed to each other around the window 112 and along a generally horizontal direction (i.e., along a plane direction of the lens mounting plate 110), and a second pair of protrusion members 118 are also formed on the rear surface of the board support plate 114 at respective positions opposed to each other around the window 112 and along a generally vertical direction (i.e., along a direction upwardly apart from the lens mounting plate 110) crossing a center of the window 112. The circuit board 36 is supported by the rear surface the board support plate 114, in such a manner that it is in contact with the first pair of protrusion members 116 and the second pair of protrusion members 118, while allowing the light-receiving surface of the image pickup device 34 to face (i.e., be exposed to) the imaging lens 38 through the window 112.

Specifically, the circuit board 36 is made of a resin material, and formed with a plurality of insertion holes, wherein the image pickup device 34 is mounted to a specific one of opposite surfaces of the circuit board 36 in such a manner that a plurality of pin terminals of the image pickup device 34 are inserted into the insertion holes and connected to a wiring pattern of the circuit board 36 using an electrically conductive fixing material, such as solder, and a plurality of IC devices 128 constituting a driving circuit for driving the image pickup device 34 are also mounted to the same surface of the circuit board 36, i.e., to one surface of the circuit board 36 which is identical to the specific surface having the image pickup device 34 mounted thereto, in such a manner that a plurality of pin terminals of the IC devices 128 are inserted into the insertion holes and connected to the wiring pattern of the circuit board 36 using an electrically conductive fixing material, such as solder. This circuit board 36 is supported by board support plate 114 through an operation of bringing the specific surface of the circuit board 36 into contact with the protrusion members 116, 118 of the board support plate 114, and then fixedly fastening horizontally opposite ends of the circuit board 36 (i.e., opposite ends of the circuit board 36 in the plane direction of the lens mounting plate 110), to the board support plate 114 using a pair of fastening members 120, such as screws. That is, in this embodiment, the first and second pairs of protrusion members 116, 118 are provided in a region between the horizontally opposite ends of the rear surface of the board support plate 114 (i.e., a region between the pair of fastening members 120 in the rear surface of the board support plate 114).

The above image forming apparatus 10 is operated as follows. Firstly, a stack of documents are placed on the automatic document feeder 46, and a member of sheets to be subjected to an image forming process, a desired image density, a desired enlargement/reduction factor, etc., are set using a manual operation panel (not shown). Then, in response to an operation of manually turning on a start button (not shown), the documents are sequentially fed onto the first contact glass 48 to pass through the upper surface thereof. In this process, light is emitted from the exposure light source 24 stopped at a position corresponding to the first contact glass 48, and resulting reflected light from a document surface is led to the image pickup device 34 mounted to the circuit board 36, via the first optical system 18 and the second optical system 20. The document-induced reflected light, i.e., document image, is picked up by the image pickup device 34, and stored in the storage device (not shown). The documents passing through the upper surface of the first contact glass 48 are ejected to the tray portion formed on the upper surface of the document presser member 44.

When a plurality of documents are bound in the form of a book or the like, the document presser member 44 is opened, and the documents are placed on the second contact glass 50. Then, after setting a member of sheets to be subjected to an image forming process, a desired image density, a desired enlargement/reduction factor, etc., by use of the manual operation panel (not shown), the start button (not shown) is manually turned on. In response to the turn-on operation, the exposure light source 24 is scanned along a document surface to irradiate the document surface with light. Resulting reflected light from the document surface is led to the image pickup device 34 mounted to the circuit board 36, via the first optical system 18 and the second optical system 20. Thus, the document-induced reflected light, i.e., document image, is picked up by the image pickup device 34, and stored in the storage device (not shown).

Concurrently, the outer peripheral surface of the photosensitive drum 70 is electrically charged by the charger 72. Then, a laser beam corresponding to the document image stored in the storage device (not shown) is emitted from the laser scanner unit 52, and deflected by the polygon mirror 62. Thus, the outer peripheral surface of the photosensitive drum 70 is irradiated with, i.e., exposed to, the deflected light to form an electrostatic latent image thereon. Toner is then supplied from the developing module 74 onto the photosensitive drum 70, so that the toner is attached to the electrostatic latent image to form a toner image on the outer peripheral surface of the photosensitive drum 70.

A recording sheet received in the sheet cassette PC is transferred to a registration roller pair through the upstream transfer passage 104 by the sheet-feeding roller (not shown), and then transferred to a zone between the photosensitive drum 70 and the transfer roller 82 in synchronization with the formation of the electrostatic latent image. When the sheet transported to the zone between the photosensitive drum 70 and the transfer roller 82, the toner image on the photosensitive drum 70 is transferred onto the sheet by an action of the transfer roller 82 applied with a voltage having a polarity opposite to that of the electrostatic latent image. Then, the sheet released from the photosensitive drum 70 is transported to the fixing unit 56 through the downstream transport passage 108, and, after completion of the fixing process, ejected to the catch tray 106.

After completion of a toner-image transfer process, toner and charges remaining on the outer peripheral surface of the photosensitive drum 70 are removed by the cleaning module 76 and the light-emitting module 78, respectively. Subsequently, the above operation will be repeatedly performed in sequence to subject the desired number of sheets to the image forming process.

As described based on the above embodiment, in an image forming apparatus 10 equipped with an image reader of the present invention, an image pickup unit 22 constituting an image reading section 12 is designed such that a circuit board 36 mounting an image pickup device 34 and an IC device 128 to the same surface thereof is fixedly fastened to a board support plate 114 at horizontally opposite ends of a rear surface of the board support plate 114, while allowing the circuit board 36 to be in contact with a protrusion member 116, 118 provided in a region between the horizontally opposite ends, so as to support the circuit board 36 by the board support plate 114. This makes it possible to effectively suppress warping of the circuit board 36 which can otherwise be caused by heat generated from the image pickup device 34 and the IC device 128, so as to effectively suppress deterioration in image quality due to warping of the circuit board 36 caused by heat generated from the image pickup device 34 and the IC device 128.

Specifically, even if the circuit board 36 increases in temperature due to heat generated from the image pickup device 34 and the IC device 128, and thereby an amount of linear expansion in a mounting surface (i.e., front surface) of the circuit board 36 for the image pickup device 34 and the IC device 128 becomes greater than that in the other surface (i.e., rear surface) of the circuit board 36, to increase the risk of convex warping in the front surface of the circuit board 36, the protrusion member 116, 118 in contact with the circuit board 36 fixedly fastened to the board support plate 114 can block deformation of the circuit board 36 so as to suppress the occurrence of warping in the circuit board 36. In addition, the amount of linear expansion in the rear surface of the circuit board 36 never becomes greater than that in the front surface of the circuit board 36. Thus, a distance between the image pickup device 34 and an imaging lens 38 will be maintained in the same value as a normal distance adjusted during assembling. This makes it possible to effectively suppress deterioration in image quality due to warping of the circuit board 36 caused by heat generated from the image pickup device 34 and the IC device 128.

In the image forming apparatus 10 equipped with the image reader of the present invention, the protrusion member 116, 118 allows a given space to be defined between the circuit board 36 and the board support plate 114, and the IC device 128 is located within the given space. Thus, the board support plate 114 can protect the IC device 128 to provide enhanced reliability free from damages to the IC device 128.

The image forming apparatus 10 equipped with the image reader of the present invention is not limited to the above embodiment, but various changes and modifications may be made therein according to need, without departing from the spirit and scope thereof as set forth in appended claims. Some examples will be described below.

(1) While the board support plate 114 in the above embodiment has the window 112 formed in a central region thereof, the present invention is not limited to this structure, but the board support plate 114 may be devoid of such a window. In this case, the image pickup device 34 is positioned on the front surface of the board support plate 114 on the side of the imaging lens 38, and the board support plate 114 is formed with a through-hole for allowing the pin terminal 126 to penetrate therethrough so as to enable connection with the wiring pattern on the rear surface of the circuit board 36. If the board support plate 114 is made of a metal material, it is necessary to ensure electrical insulation between the through-hole and the pin terminal 126, for example, by forming the through-hole in a relatively large size. However, the board support plate 114 having the window 112 formed in a central region thereof has an advantage of allowing the circuit board 36 to be assembled independently of the board support plate 114 to facilitate the assembling operation.

(2) While the circuit board 36 in the above embodiment is fixedly fastened to the board support plate 114 at the horizontally opposite ends thereof by the fastening member 120, the present invention is not limited to this fastening structure. For example, the circuit board 36 may be fixedly fastened to the board support plate 114 at the horizontally opposite ends thereof through a spacer by use of an adhesive. Further, in the fastening structure using the fastening member 120, the circuit board 36 may be fixedly fastened to the board support plate 114 in such a manner that a spacer is interposed between the circuit board 36 and the board support plate 114, and the fastening member 120 is arranged to penetrate through the spacer.

(3) While the board support plate 114 in the above embodiment is made of a rigid material, the present invention is not limited to such a material. For example, in cases where the board support plate 114 is reliably fixed to the lens mounting plate 110, the board support plate 114 may be made of a soft material, such as a soft resin material.

(4) While the board support plate 114 in the above embodiment is disposed to extend upwardly from the position where it is fixedly fastened to an edge surface of one end of the lens mounting plate 110, the present invention is not limited to this fastening structure. For example, the board support plate 114 may be fixedly fastened to an upper surface of one end of the lens mounting plate 110 by use, for example, of a screw member. What is important is a structure where the board support plate 114 extends upwardly relative to the lens mounting plate 110.

(5) While the board support plate 114 in the above embodiment is formed to have the first pair of protrusion members 116 and the second pair of protrusion members 118 around the window 112, the present invention is not limited to this structure. For example, the board support plate 114 may have only two protrusion members 118 located at respective positions opposed to each other around the window 112 and along a generally vertical direction. Alternatively, in addition to the first pair of protrusion members 116 and the second pair of protrusion members 118, one or more protrusions may further be provided.

(6) While the second pair of protrusion members 118 in the above embodiment is provided at respective positions opposed to each other around the window 112 and along a generally vertical direction crossing a center of the window 112, the present invention is not limited to this arrangement. For example, the second pair of protrusion members 118 may be provided at respective positions deviated from the center of the window 112.

As above, the present invention may be summarized as follows.

An image reader of the present invention is designed to read an image of a document by an optical system and focus the document image onto a light-receiving surface of an image pickup device through an imaging lens. The image reader comprises an image pickup unit including: a lens mounting plate which mounts thereto the imaging lens; a circuit board which mounts, to a same surface thereof, the image pickup device and an IC device constituting a driving circuit for the image pickup device; and a board support plate disposed to extend upwardly relative to the lens mounting plate in opposed relation to the imaging lens and formed to support the circuit board by a rear surface thereof located on an opposite side of the imaging lens, in such a manner as to allow a light-receiving surface of the image pickup device to face the imaging lens, wherein the circuit board is in contact with a protrusion member provided in a region between horizontally opposite ends of the rear surface of the board support plate, and fixedly fastened to the board support plate at the horizontally opposite ends by use of a fastening member.

In the image reader of the present invention, the circuit board is designed to mount, to the same surface thereof, the image pickup device and the IC device, and the board support plate is designed to support the circuit board while allowing the circuit board to be in contact with the protrusion member provided on the rear surface thereof. Thus, the image reader of the present invention can suppress the occurrence of convex warping in the surface of the circuit board having the image pickup device and the IC device mounted thereto, to eliminate the risk of deterioration in image quality due to warping of the circuit board caused by heat generated from the image pickup device and the IC device.

In the image reader of the present invention, the board support plate may be formed with a window in a central region thereof, and the image pickup device may be positioned to allow the light-receiving surface thereof to face the imaging lens through the window.

According to this feature, the board support plate is formed with a window in a central region thereof, and the image pickup device is positioned to allow the light-receiving surface thereof to face the imaging lens through the window. This allows the image pickup device to be located between the circuit board and the board support plate. Thus, the board support plate can protect the light-receiving surface of the image pickup device to provide enhanced reliability to the image reader.

In the above image reader, the protrusion member may include at least two protrusion members provided on the rear surface of the board support plate at respective positions opposed to each other around the window and along a generally vertical direction.

According to this feature, at least two protrusion members are provided at respective positions opposed to each other around the window and along a generally vertical direction. This makes it possible to reliably suppress convex warping in the surface of the circuit board having the image pickup device and the IC device mounted thereto so as to allow the image reader to become free from deterioration in image quality due to warping of the circuit board caused by heat generated from the image pickup device and the IC device.

Any of the above image readers may be applied to an image forming apparatus designed to focus a document image read by an optical system, onto a light-receiving surface of an image pickup device through an imaging lens, and write an electrostatic latent image onto a photosensitive drum based on image data obtained by the image reader.

In the image forming apparatus of the present invention, the circuit board is designed to mount, to the same surface thereof, the image pickup device and the IC device, and the board support plate is designed to support the circuit board while allowing the circuit board to be in contact with the protrusion member provided on the rear surface thereof. Thus, the image forming apparatus of the present invention can suppress the occurrence of convex warping in the surface of the circuit board having the image pickup device and the IC device mounted thereto, to eliminate the risk of deterioration in image quality due to warping of the circuit board caused by heat generated from the image pickup device and the IC device.

This application is based on Japanese Patent Application Serial No. 2007-012330 filed in Japan Patent Office on Jan. 23, 2007, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image reader designed to read an image of a document by an optical system and focus said document image onto a light-receiving surface of an image pickup device through an imaging lens, said image reader comprising an image pickup unit which includes:
a lens mounting plate which mounts thereto said imaging lens;
a circuit board which mounts, to a same surface thereof, said image pickup device and an IC device constituting a driving circuit for said image pickup device;
a board support plate disposed to extend upwardly relative to said lens mounting plate in opposed relation to said imaging lens and formed to support said circuit board in such a manner as to allow a light-receiving surface of said image pickup device to face said imaging lens;
a protrusion member provided in a region between horizontally opposite ends of a rear surface of said board support plate; and
a fastening member for fixedly fastening said circuit board and said board support plate together, said fastening member being adapted to fixedly fasten said circuit board to said board support plate while interposing said protrusion member between said circuit board and said board support plate.

2. The image reader according to claim 1, wherein:
said board support plate is formed with a window in a central region thereof; and
said image pickup device is positioned to allow said light-receiving surface thereof to face said imaging lens through said window.

3. The image reader according to claim 2, wherein said protrusion member includes at least two protrusion members provided on said rear surface of said board support plate at respective positions opposed to each other around said window and along a generally vertical direction.

4. The image reader according to claim 3, wherein said protrusion member further includes at least two protrusion members provided on said rear surface of said board support plate at respective positions opposed to each other around said window and along a generally horizontal direction.

5. The image reader according to claim 1, wherein said image pickup device is mounted to said circuit board through a pin terminal.

6. The image reader according to claim 5, wherein said image pickup device is mounted to said circuit board through said pin terminal in such a manner as to allow a surface of said image pickup device on an opposite side of said light-receiving surface to be positioned in spaced-apart relation to said circuit board by a predetermined distance.

7. An image forming apparatus equipped with an image reader adapted to read an image of a document by an optical system and focus said document image onto a light-receiving surface of an image pickup device through an imaging lens, and designed to write an electrostatic latent image onto a photosensitive drum based on image data obtained by said image reader, wherein said image reader comprises an image pickup unit which includes:
a lens mounting plate which mounts thereto said imaging lens;
a circuit board which mounts, to a same surface thereof, said image pickup device and an IC device constituting a driving circuit for said image pickup device;
a board support plate disposed to extend upwardly relative to said lens mounting plate in opposed relation to said imaging lens and formed to support said circuit board in such a manner as to allow a light-receiving surface of said image pickup device to face said imaging lens;
a protrusion member provided in a region between horizontally opposite ends of a rear surface of said board support plate; and
a fastening member for fixedly fastening said circuit board and said board support plate together, said fastening member being adapted to fixedly fasten said circuit board to said board support plate while interposing said protrusion member between said circuit board and said board support plate.

8. The image forming apparatus according to claim 7, wherein:
said board support plate is formed with a window in a central region thereof; and
said image pickup device is positioned to allow said light-receiving surface thereof to face said imaging lens through said window.

9. The image forming apparatus according to claim 8, wherein said protrusion member includes at least two protrusion members provided on said rear surface of said board support plate at respective positions opposed to each other around said window and along a generally vertical direction.

10. The image forming apparatus according to claim 9, wherein said protrusion member further includes at least two protrusion members provided on said rear surface of said board support plate at respective positions opposed to each other around said window and along a generally horizontal direction.

11. The image forming apparatus according to claim 7, wherein said image pickup device is mounted to said circuit board through a pin terminal.

12. The image forming apparatus according to claim 11, wherein said image pickup device is mounted to said circuit board through said pin terminal in such a manner as to allow a surface of said image pickup device on an opposite side of said light-receiving surface to be positioned in spaced-apart relation to said circuit board by a predetermined distance.

13. An image reader designed to read an image of a document by an optical system and focus said document image onto a light-receiving surface of an image pickup device through an imaging lens, said image reader comprising an image pickup unit which includes:
a lens mounting plate which mounts thereto said imaging lens;
a circuit board which mounts, to a same surface thereof, said image pickup device and an IC device constituting a driving circuit for said image pickup device;
a board support member disposed to extend upwardly relative to said lens mounting plate in opposed relation to said imaging lens and formed to support said circuit board in such a manner as to allow a light-receiving surface of said image pickup device to face said imaging lens, said board support member being formed with a window in a central region thereof, wherein said image pickup device is positioned to allow said light-receiving surface thereof to face said imaging lens through said window;
a plurality of spacers provided in a region between horizontally or vertically opposite ends of a rear surface of said board support member; and
a fastening member for fixedly fastening said circuit board and said board support plate together, said fastening member being adapted to fixedly fasten said circuit board to said board support plate while interposing said spacers between said circuit board and said board support plate so as to allow said image pickup device to avoid surface contact with said circuit board.
